(19) United States
(12) Patent Application Publication
(10) Pub. No.: US 2019/0176174 A1
(43) Pub. Date: Jun. 13, 2019

(54) BUTTON-LOCK FLUID CONNECTOR FOR HAND-HELD SPRAY GUNS

(71) Applicant: 3M INNOVATIVE PROPERTIES COMPANY, St. Paul, MN (US)

(72) Inventors: Alexander T. Ebertowski, Burnsville, MN (US); Stephen C.P. Joseph, Woodbury, MN (US); Anna M. Hegdahl, Brooklyn Park, MN (US); Andrew R. Henry, Leicestershire (GB)

(21) Appl. No.: 16/069,847

(22) PCT Filed: Jan. 12, 2017
(86) PCT No.: PCT/US2017/013131

§ 371 Date: Jul. 12, 2018

Related U.S. Application Data
(60) Provisional application No. 62/279,537, filed on Jan. 15, 2016.

(51) Int. Cl. B05B 7/24

(52) U.S. Cl. CPC B05B 7/2408; B05B 7/2478

(57) ABSTRACT

A spray gun reservoir connector system. The system includes a reservoir lid, a spray gun inlet, and complementary first and second connector formats. The first and second connector formats are provided with one of either the lid or the spray gun inlet. The first format includes a plurality of retention structures each defining a slot. The retention structures are collectively arranged in a circular pattern. The second format includes a plurality of lock structures each including a stem and a button head configured to selectively interface with the slots. The connector formats are configured to provide wedged engagement between the lock structures and corresponding ones of the retention structures upon rotation of the spray gun inlet relative to the lid.

### BACKGROUND

The present disclosure relates to liquid spraying apparatuses, such as spray guns. More particularly, it relates to the connection between a spray gun and a reservoir containing the liquid to be sprayed.

Spray guns are widely used in vehicle body repair shops when re-spraying a vehicle that has been repaired following an accident. In the known spray guns, the liquid is contained in a reservoir attached to the gun from where it is fed to a spray nozzle. On emerging from the spray nozzle, the liquid is atomized and forms a spray with compressed air supplied to the nozzle. The liquid may be gravity fed or suction fed or, more recently, pressure fed by an air bleed line to the reservoir from the compressed air line to the spray gun, or from the spray gun itself

### Summary

Traditionally, the liquid is contained in a rigid reservoir or pot removably mounted on the spray gun. In this way, the pot can be removed for cleaning or replacement. Previously, the pot was secured to the gun empty and provided a removable lid by which the desired liquid could be added to the pot while attached to the gun. On completion of spraying, the pot can be removed and the gun and pot cleaned for re-use.

More recently, reservoir assemblies have been developed that enables painters to mix less paint and drastically reduce the amount of technician time required for gun cleaning. The PPS™ Paint Preparation System available from 3M Company of St. Paul, Minn. provides a reservoir that eliminates the need for traditional mixing cups and paint strainers. The PPS™ Paint Preparation System reservoir includes a reusable outer container or cup, an open-topped liner and a lid. The liner is a close fit in the outer container, and paint (or other liquid) that is to be dispensed is held within the liner. The lid is assembled to the liner and provides a spout or conduit through which the contained paint is conveyed. In use, the liner collapses as paint is withdrawn and, after spraying, the liner and lid can be removed allowing a new, clean liner and lid to be employed for the next use of the spray gun. As a result, the amount of cleaning required is considerably reduced and the spray gun can be readily adapted to apply different paints in a simple manner.

Regardless of exact format, the reservoir or pot incorporates one or more connection features that facilitate removable assembly or attachment to the spray gun. In many instances, the spray gun and reservoir are designed in tandem, providing complementary connection formats that promote direct assembly of the reservoir to the spray gun. In other instances, an adaptor is employed between the reservoir and spray gun. The adaptor has a first connection format at one end that is compatible with the spray gun and a second connection format at an opposite end that is compatible with the reservoir. With either approach, releasable connection between the spray gun and reservoir was conventionally achieved via standard screw thread connection format. Other connection formats have also been suggested, such as a releasable quick-fit connection employing bayonet type formations that are engageable with a push-twist action requiring less than one complete turn of the reservoir to connect/disconnect the reservoir as described, for example, in U.S. Application Publication No. 2013/0221130 the entire teachings of which are incorporated herein by reference. To minimize the possibility of accidental release of the reservoir or diminished fluid-tight seal between the reservoir and spray gun, it has further been suggested to incorporate security clips into the complimentary connection format as described in U.S. Pat. No. 7,083,119, the entire teachings of which are incorporated herein by reference. While these and other connection formats have greatly improved the ease and confidence of removable connection between the reservoir and spray gun, opportunities for improvement remain.

The inventors of the present disclosure recognized that a need exists that overcomes one or more of the above-mentioned problems

Some aspects of the present disclosure are directed toward a spray gun reservoir connector system. The system includes a reservoir, a spray gun inlet, a first connector format and a second connector format. The reservoir includes a lid. The first connector format is provided with one of the lid and the spray gun inlet; the second connector format is provided with the other of the lid and the spray gun inlet. The first connector format includes a plurality of retention structures each defining a slot. The retention structures are collectively arranged in a circular pattern and are circumferentially spaced from one another. The second connector format includes a plurality of lock structures each including a stem and a button head configured to selectively interface with the slot of a respective one of the retention structures. The lock structures are collectively arranged in a circular pattern and are circumferentially spaced from one another. The connector formats are configured to provide robust engagement between the lock structures and corresponding ones of the retention structures upon rotation of the spray gun inlet relative to the lid. In some embodiments, the lid further includes a liquid outlet or spout, and the corresponding retention structures or lock structures are radially spaced outside of the spout.

The connector systems of the present disclosure facilitate simple and quick mounting (and removal) of a reservoir to a spray gun (either directly to the spray gun, or to an adaptor that in turn is mounted to the spray gun). The complementary connector formats are aligned then rotated relative to one another to achieve a locked, liquid sealed connection.

As used herein, the term “liquid” refers to all forms of flowable material that can be applied to a surface using a spray gun (whether or not they are intended to color the surface) including (without limitation) paints, primers, base coats, lacquers, varnishes and similar paint-like materials as well as other materials, such as adhesives, sealer, fillers, putties, powder coatings, blasting powders, abrasive slurries, mold release agents and foundry dressings which may be applied in atomized or non-atomized form depending on the properties and/or the intended application of the material and the term “liquid” is to be construed accordingly.

The present disclosure includes, but is not limited to, the following exemplary embodiments:
1. A spray gun reservoir connector system comprising:
   a reservoir including a lid;
   a spray gun inlet;
   a first connector format provided with one of the lid and the spray gun inlet, the first connector format including a plurality of retention structures projecting from a base to define a plurality of slots, wherein the retention structures are collectively arranged in a circular pattern and are circumferentially spaced from one another; and
   a second connector format provided with the other of the lid and the spray gun inlet, the second connector format including a plurality of lock structures each including a stem and a button head configured to selectively interface with the slot of a respective one of the retention structures, wherein the lock structures are collectively arranged in a circular pattern and are circumferentially spaced from one another;
   wherein the connector formats are configured to provide engagement between the lock structures and corresponding ones of the retention structures upon rotation of the spray gun inlet relative to the lid.
2. The connector system of Embodiment 1, wherein the first connector format is provided with the lid and the second connector format is provided with the spray gun inlet.
3. The connector system of Embodiment 2, wherein the lid further includes a liquid outlet, and further wherein the retention structures are arranged about, and radially spaced from, the liquid outlet.
4. The connector system of Embodiment 1, wherein the second connector format is provided with the lid and the first connector format is provided with the spray gun inlet.
5. The connector system of Embodiment 4, wherein the lid further includes a liquid outlet, and further wherein the lock structures are arranged about, and radially spaced from, the liquid outlet.
6. The connector system of Embodiment 1, wherein the spray gun inlet is on an adaptor adapted to connect to a spray gun.
7. The connector system of Embodiment 6, wherein the adaptor further includes a tubular member and a connector feature configured for connection to a spray gun inlet port.
8. The connector system of Embodiment 6, wherein the first connection format is provided with the adaptor, and further wherein the retention bodies collectively form an S-like shape.
9. The connector system of any of Embodiments 1-8, wherein the spray gun inlet is integral with a spray gun.
10. The connector system of any of Embodiments 1-9, wherein the retention structures each include a retention body defining a foot segment and a leg segment.
11. The connector system of any of Embodiments 1-10, wherein the retention structures further include a groove along the corresponding retention body configured to engage a lip of a corresponding one of the button heads.
12. The connector system of Embodiment 11, wherein the button head defines an engagement surface configured to slidably abut a bearing surface formed along a corresponding one of the grooves.
13. The connector system of Embodiment 12, wherein the engagement surface is configured to provide a wedged interface with the bearing surface.
14. The connector system of any of Embodiments 1-13, wherein a profile of the button head defines an ellipse-like shape.
15. A spray gun reservoir connector system adapter comprising a first connector format comprising a plurality of retention structures projecting from a base to define a plurality of slots, wherein the retention structures are collectively arranged in a circular pattern and are circumferentially spaced from one another.
16. A spray gun reservoir connector system adapter comprising a second connector format comprising a plurality of lock structures each including a stem and a button head configured to selectively interface with the slot of a retention structure on a compatible first connector format, wherein the lock structures are collectively arranged in a circular pattern and are circumferentially spaced from one another.
17. A spray gun reservoir component comprising a first connector format comprising a plurality of retention structures projecting from a base to define a plurality of slots, wherein the retention structures are collectively arranged in a circular pattern and are circumferentially spaced from one another.
18. The spray gun reservoir component of Embodiment 17, wherein the component is a lid.
19. The spray gun reservoir component of Embodiment 17, wherein the component is a pot.
20. A spray gun reservoir component comprising a second connector format comprising a plurality of lock structures each including a stem and a button head configured to selectively interface with the slot of a retention structure on a compatible first connector format, wherein the lock structures are collectively arranged in a circular pattern and are circumferentially spaced from one another.
21. The spray gun reservoir component of Embodiment 20, wherein the component is a lid.
22. The spray gun reservoir component of Embodiment 20, wherein the component is a pot.

### BRIEF DESCRIPTION OF THE DRAWINGS

FIG. 1 is a simplified perspective view of a spray gun assembly including a spray gun and a reservoir;

FIG. 2 is an exploded view of a reservoir incorporating a connection format in accordance with principles of the present disclosure;

FIG. 3 is a perspective view of a portion of a spray gun reservoir connector system in accordance with principles of the present disclosure and including complimentary connection formats;

FIG. 4A is a perspective view of a lid portion of the reservoir of FIG. 3;

FIG. 4B is a front view of the lid of FIG. 4A;

FIG. 4C is a side view of the lid of FIG. 4A;

FIG. 4D is top view of the lid of FIG. 4A;

FIG. 4E is a longitudinal cross-sectional view of the lid of FIG. 4A;

FIG. 5A is an enlarged perspective view of a portion of the lid of FIG. 4A;

FIG. 5B is an enlarged cross-sectional view of a portion of the lid of FIG. 4A;

FIG. 5C is an enlarged side view of a portion of the lid of FIG. 4A;

FIG. 6A is a perspective view of an adaptor useful with the connector systems of the present disclosure and including a connection format complementary with the connection format of the lid of FIG. 4A;

FIG. 6B is another perspective view of the adaptor of FIG. 6A;

FIG. 6C is a top view of the adaptor of FIG. 6A;

FIG. 6D is a longitudinal cross-sectional view of the adaptor of FIG. 6A;

FIGS. 7-10C illustrate assembly of the connector system of FIG. 3, including coupling the lid of FIG. 4A with the adaptor of FIG. 6A;

FIG. 11 is an exploded, perspective view of another spray gun reservoir connector system in accordance with principles of the present disclosure and incorporated into a reservoir lid and an adaptor;

FIG. 12 is an exploded, perspective view of another spray gun reservoir connector system in accordance with principles of the present disclosure and incorporated into a reservoir lid and an adaptor;

FIG. 13A is a perspective view of the lid of FIG. 12;

FIG. 13B is a side view of the lid of FIG. 13A;

FIG. 13C is a front view of the lid of FIG. 13A;

FIG. 13D is a top view of the lid of FIG. 13A;

FIG. 13E is an enlarged view of a portion of the lid of FIG. 13A;

FIGS. 14A and 14B are perspective views of the adaptor of FIG. 12;

FIG. 14C is a cross-sectional view of the adaptor of FIG. 14A; and

FIG. 15 is an exploded perspective view of a modular lid assembly incorporating a connection format in accordance with principles of the present disclosure

### DETAILED DESCRIPTION

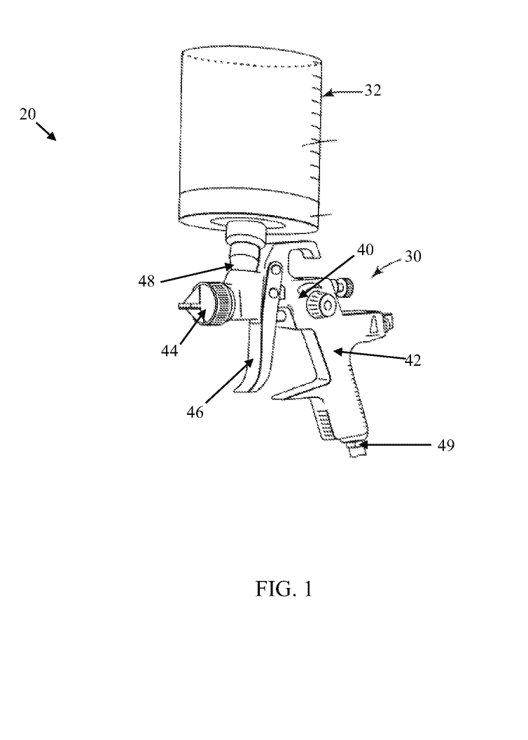

Aspects of the present disclosure are directed toward connection systems that facilitate releasable, sealed connection between a spray gun and reservoir. By way of background, FIG. 1 depicts a spray gun paint system 20 including a spray gun 30 of a gravity-feed type and a reservoir 32. The gun 30 includes a body 40, a handle 42, and a spray nozzle 44 at a front end of the body 40. The gun 30 is manually operated by a trigger 46 that is pivotally mounted on the sides of the body 40. An inlet port 48 (reference generally) is formed in or carried by the body 40, and is configured to establish a fluid connection between an interior spray conduit (hidden) of the spray gun 30 and the reservoir 32. The reservoir 32 contains liquid (e.g., paint) to be sprayed, and is connected to the inlet port 48 (it being understood that the connection implicated by the drawing of FIG. 1 does not necessarily reflect the connections of the present disclosure). In use, the spray gun 30 is connected via a connector 49 at a lower end of the handle 42 to a source of compressed air (not shown). Compressed air is delivered through the gun 30 when the user pulls on the trigger 46 and paint is delivered under gravity from the reservoir 32 through the spray gun 30 to the nozzle 44. As a result, the paint (or other liquid) is atomized on leaving the nozzle 44 to form a spray with the compressed air leaving the nozzle 44.

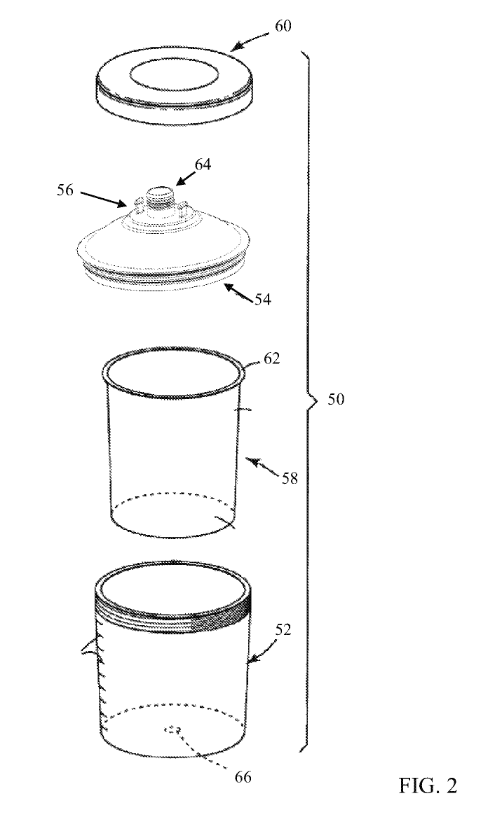

For ease of illustration, connection formats of the present disclosure between the spray gun 30 and the reservoir 32 are not included with the drawing of FIG. 1. In general terms, the reservoir 32 includes one or more components establishing a first connection format for connection to the spray gun 30. A complementary, second connection format is included with an adaptor (not shown) assembled between the reservoir 32 and the inlet port 48, or with the spray gun 30. With this background in mind, FIG. 2 illustrates one non-limiting example of a reservoir 50 in accordance with principles of the present disclosure. The reservoir 50 includes an outer container 52 and a lid 54. The lid 54 includes or provides a first connection format or feature 56 (referenced generally) described in greater detail below. Remaining components of the reservoir 50 can assume various forms and are optional. For example, in some embodiments the reservoir 50 further includes a liner 58 and a collar 60. In general terms, the liner 58 corresponds in shape to (and is a close fit in) the interior of the container 52 and can have a narrow rim 62 at the open end which sits on the top edge of the container 52. The lid 54 is configured to push-fit in the open end of the liner 58 to locate the peripheral edge of the lid 54 over the rim 62 of the liner 58. The lid/liner assembly is secured in place by the annular collar 60 that releasably engages the container 52 (e.g., threaded interface as shown, snap fit, etc.).

In addition to the connection format 56, the lid 54 forms a liquid outlet 64 (referenced generally) through which liquid contained by the liner 58 can flow. In use, the liner 58 collapses in an axial direction toward the lid 54 as paint is withdrawn from the reservoir 50. An optional vent hole 66 in the base of the outer container 52 allows air to enter as the liner 58 collapses. On completion of spraying, the reservoir 50 can be detached from the spray gun 30 (FIG. 1), the collar 60 released and the lid/liner assembly removed from the outer container 52 in one piece. The outer container 52 and the collar 60 are left clean and ready for re-use with a fresh liner 58 and lid 54. In this way, excessive cleaning of the reservoir 50 can be avoided.

In other embodiments, the reservoirs of the present disclosure need not include the liner 58 and/or the collar 60. The connection formats of the present disclosure can be implemented with a plethora of other reservoir configurations that may or may not be directly implicated by the figures.

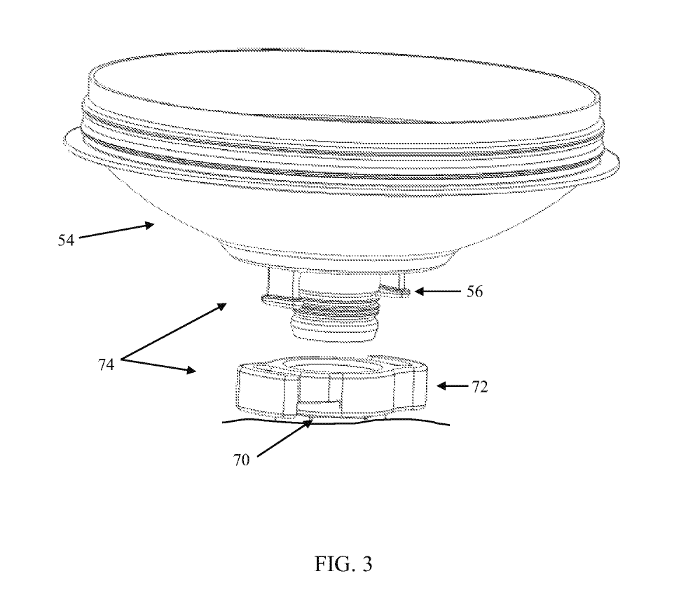

As mentioned above, the first connection format 56 provided with the lid 54 is configured to releasably connect with a complementary second connection format provided with a spray gun inlet or apparatus. As point of reference, FIG. 3 illustrates the lid 54 along with a portion of a spray gun inlet 70 that otherwise carries or provides a second complementary connection format 72 (referenced generally). The spray gun inlet 70 can be an adaptor, an integral portion of the spray gun 30 (FIG. 1), etc. Regardless, the first and second connection formats 56, 72 are configured in tandem, promoting a releasable, liquid-tight sealed mounting or connection between the lid 54 and the spray gun inlet 70. In some embodiments, the first and second complementary connection formats 56, 72 can be viewed as collectively defining a spray gun reservoir connector system 74 in accordance with principles of the present disclosure.

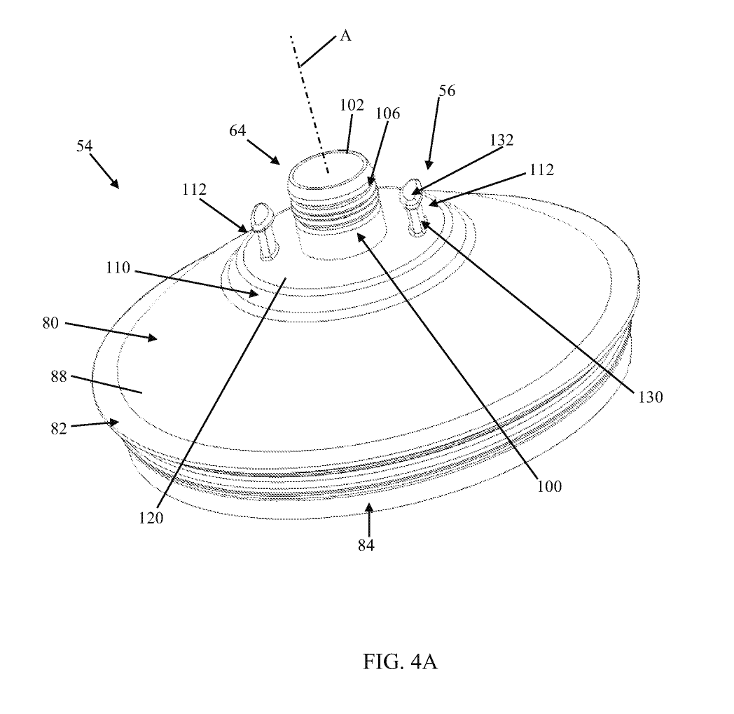

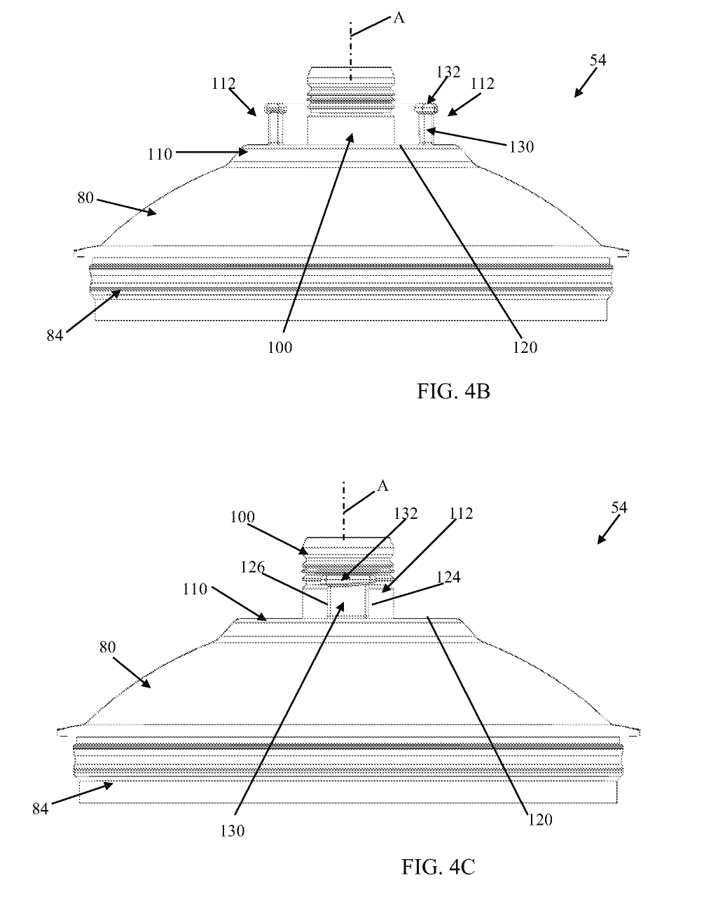

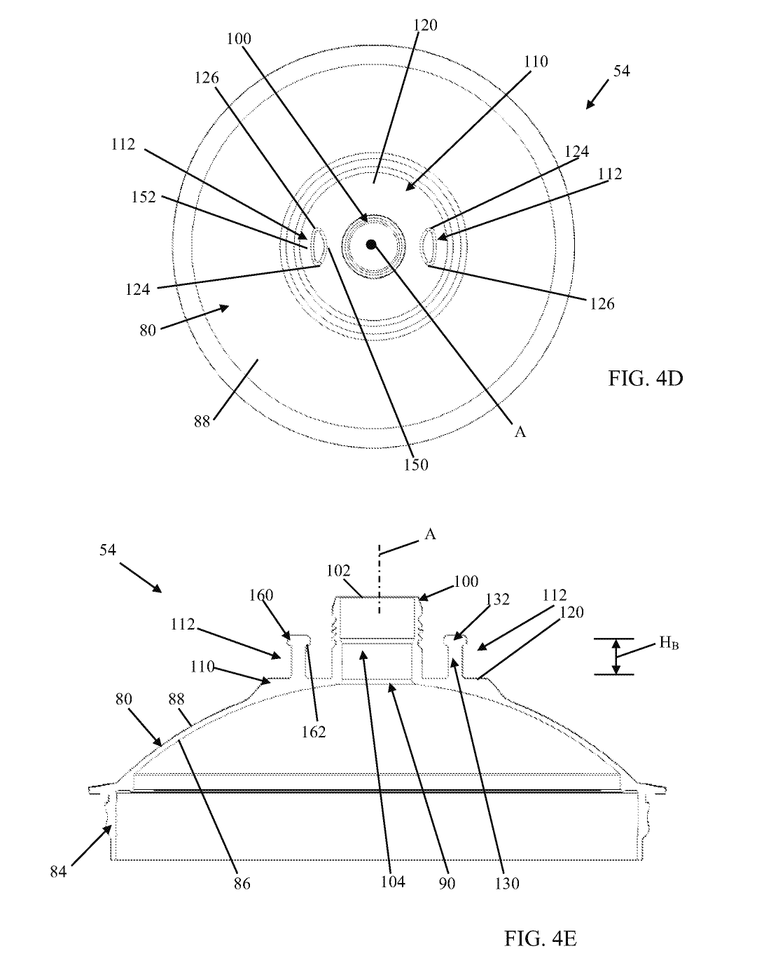

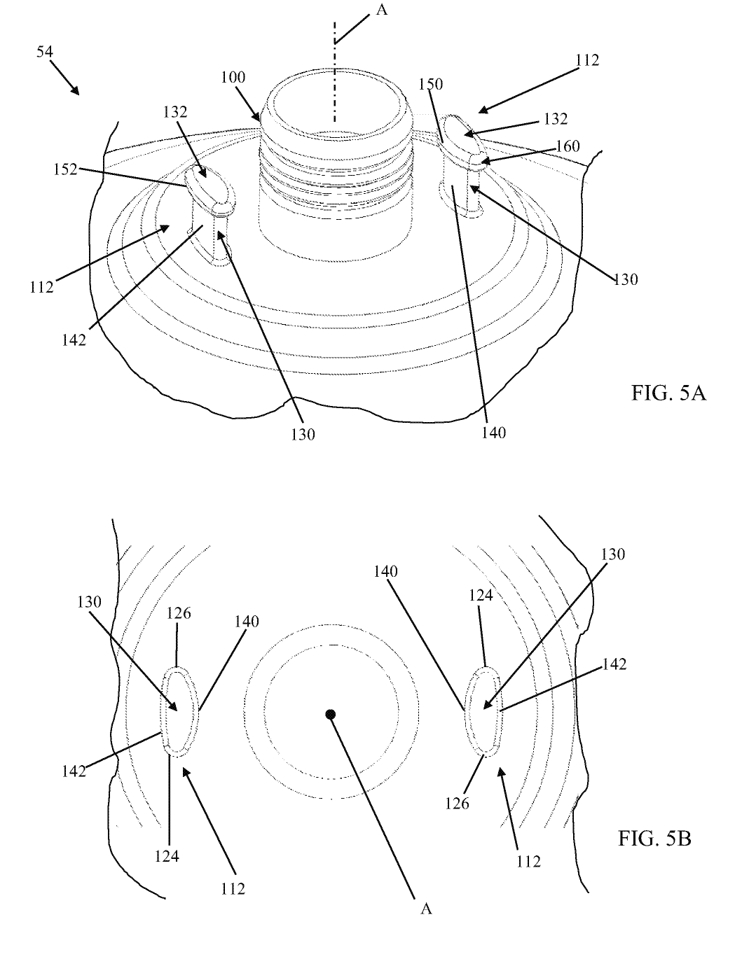

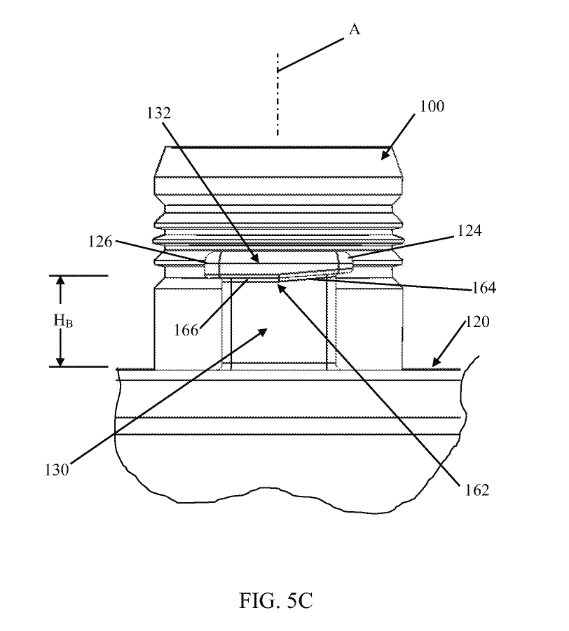

The first connection format 56 is now described with reference to FIGS. 4A-4E that otherwise illustrate the lid 54 in isolation. A shape of the lid 54 can be viewed as defining a longitudinal axis A. In addition to the first connection format 56 and the fluid outlet 64, the lid 54 includes or defines a wall 80, a flange 82, and a hub 84. The wall 80 defines opposing, inner and outer faces 86, 88, with at least the outer face 88 of the wall 80 having the curved (e.g., hemispherical) shape implicated by the drawings. Finally, the wall 80 defines a central opening 90 (best seen in FIG. 4E) that is co-axial with the longitudinal axis A. The flange 82 projects radially outwardly from a perimeter of the wall 80 opposite the central opening 90, and is configured to interface with one or more other components of the reservoir 50 (FIG. 2), for example the outer container 52 (FIG. 2). The hub 84 projects longitudinally (relative to the longitudinal axis A) from the flange 82 in a direction opposite the wall 80, and can is configured to interface with one or more other components of the reservoir 50, for example the liner 58 (FIG. 2). The wall 80, flange 82, and the hub 84 can assume a wide variety of other forms. Further, in other embodiments, one or both of the flange 82 and the hub 84 can be omitted.

The liquid outlet 64 includes a spout 100. The spout 100 is co-axial with the longitudinal axis A, projecting upwardly (relative to the orientation of FIG. 4A) from the wall 80 and terminating at a leading surface 102. The spout 100 defines a passage 104 (best seen in FIG. 4E) that is aligned with, and open to, the central opening 90. With this construction, liquid flow through the fluid outlet 64 (e.g., from a location within the confines of the inner face 86 of the wall 80 to a location external the spout 100) readily occurs through the central opening 90 and the passage 104.

In some embodiments, the fluid outlet 64 includes one or more additional features that can optionally be considered components of the first connection format 56. For example, one or more annular ribs 106 can be formed along an exterior of the spout 100 proximate the leading surface 102 and configured to form an annular seal with the spray gun inlet 70 (FIG. 3) upon assembly to the lid 54. Liquid tight seal(s) between the lid 54 and the spray gun inlet 70 can alternatively be promoted with a variety of other constructions that may or may not include the annular rib(s) 106.

The first connection format 56 includes a platform 110 and a plurality of lock structures 112. The platform 110 is formed on, or represents a deviation in a shape of, the outer face 88 of the wall 80 at a location external the spout 100. The lock structures 112 project from the platform 110, and are configured to facilitate selective connection or mounting with the second complementary connection format 72 (FIG. 3) as described below.

The platform 110 is formed by or extends from the outer face 88 and terminates at a contact surface 120. The contact surface 120 is configured to provide a sliding interface with the spray gun inlet (not shown), and can have a shape differing from the optional curved shape of the wall 80. In some embodiments, the contact surface 120 is substantially flat or planar (i.e., within 5% of a truly flat or planar shape) in a plane perpendicular to the longitudinal axis A. The contact surface 120 circumferentially surrounds the spout 100, extending to a diameter (or other dimension) greater than an outer diameter of the spout 100.

In some embodiments, the lock structures 112 can be identical and are each radially spaced from the spout 100. Each of the lock structures 112 defines opposing, first and second ends 124, 126, and includes a stem 130 and a button head 132. The stem 130 projects upwardly from the contact surface 120. The button head 132 extends from the stem 130 opposite the contact surface 120. The stem 130 and the button head 132 optionally incorporate one or more geometry features described below. In more general terms, a cross-sectional size of the button head 132 in a plane perpendicular to the longitudinal axis A is greater than that of the stem 130, such that the stem 130 and button head 132 combine to form a mushroom-like shape.

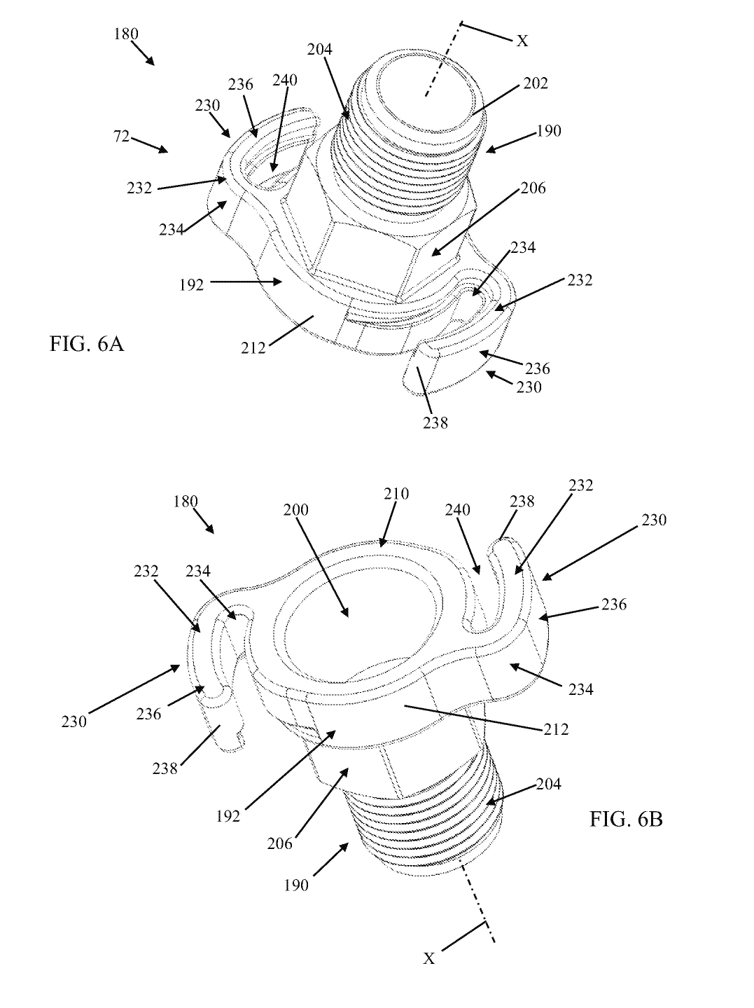

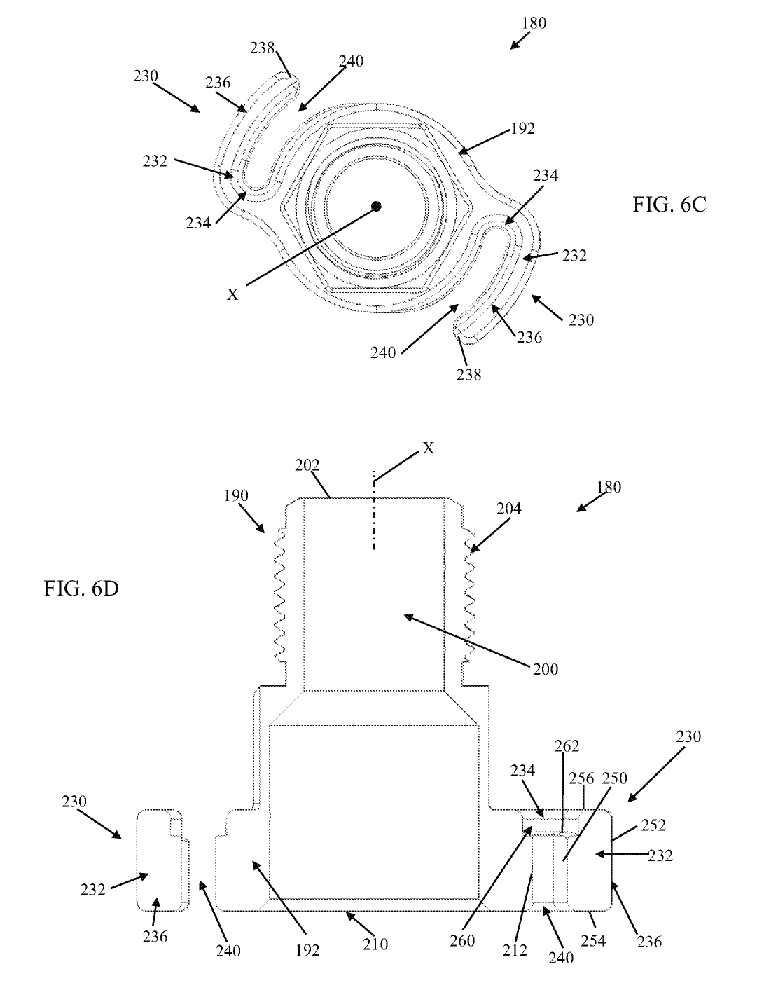

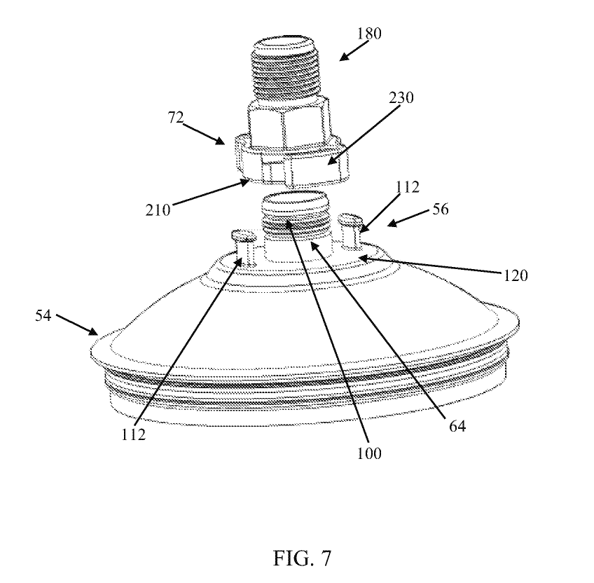

With reference to the enlarged view of FIG. 5A, each of the stems 130 defines an inner surface 140 and an outer surface 142. The inner surface 140 generally faces the spout 100, and the outer surface 142 is opposite the inner surface 140. While a shape of the inner and outer surfaces 140, 142 can be relatively uniform in the longitudinal direction, in some embodiments, one or both of the inner and outer surfaces 140, 142 can be curved in a plane perpendicular to the longitudinal axis A. For example, FIG. 5B is an enlarged cross-sectional view in a plane perpendicular to the longitudinal axis A and passing through the stem 130 of each of the lock structures 112. The inner surface 140 is non-linear or curved in extension between the first and second ends 124, 126. In some embodiments, the inner surface 140 can define a convex curvature in a cross-sectional plane perpendicular to the longitudinal axis A (e.g., the plane of FIG. 5B). Other shapes are also envisioned, and can be linear (or planar), curved, curvilinear, complex, etc. The outer surface 142 can also define a curve or curvature, such as a convex curve, between the first and second ends 124, 126 in a plane perpendicular to the longitudinal axis A (e.g., the plane of FIG. 5B). With the non-limiting example of FIG. 5B, the stem 130 can have an ellipse-like shape in a plane perpendicular to the longitudinal axis L, but a radius of curvature of the outer surface 142 is greater than that of the inner surface 140. In other embodiments, the outer surface 142 can be substantially linear or planar between the first and second ends 124, 126.

Returning to FIGS. 4A-4E, the button head 132 can generally mimic the geometry shapes described above with respect to the stem 130 at least relative to a plane perpendicular to the longitudinal axis. For example, and with reference to FIGS. 4D and 5A, the button head 132 defines an interior surface 150 and an exterior surface 152. The interior surface 150 generally faces the spout 100, and the exterior surface 152 is opposite the interior surface 150. The interior surface 150 can define a curve, such as a convex curve, in a plane perpendicular to the longitudinal axis A, between the first and second ends 124, 126 that is akin to the curvature or shape generated by the inner surface 140 of the stem 130 as described above. The exterior surface 152 can similarly form a curvature in a plane perpendicular to the longitudinal axis A between the first and second ends 124, 126 that is akin to the curvature or shape generated by outer surface 142 of the stem 130 as described above.

While a shape of the button head 132 can generally correspond with a shape of the stem 130 in a plane perpendicular to the longitudinal axis A, a footprint or size of the button head 132 is greater than that of the stem 130. Thus, the button head 132 projects radially outwardly relative to the stem 130 and generates a lip 160 defining an engagement surface 162. As shown in FIGS. 4E and 5A, the lip 160 projects beyond a shape of the stem 130 in all directions in some embodiments (e.g., the engagement surface 162 is established relative to both the inner and outer surfaces 140, 142 of the stem 130. A button height H_{B} is established as the linear distance or spacing between the engagement surface 162 and the contact surface 120. The engagement surface 162 can optionally incorporate a varying geometry between the first and second ends 124, 126 (FIG. 4D). For example, and with reference to FIG. 5C, in some embodiments, a shape of the engagement surface 162 in a plane parallel with the longitudinal axis A establishes a ramp region 164 and a trailing region 166. The ramp region 164 extends from the first end 124 to the trailing region 166, tapering slightly toward the contact surface 120. The ramp region 164 defines a plane that is oblique or non-parallel relative to a plane perpendicular to the longitudinal axis A (e.g., relative to the orientation of FIG. 5C, a plane of the ramp region 164 is oblique or non-parallel relative to horizontal). The trailing region 166 extends from the ramp region 164 to the second end 126, and can establish a plane that is parallel to a plane perpendicular to the longitudinal axis A (e.g., relative to the orientation of FIG. 5C, a plane of the trailing region 166 is horizontal or nearly horizontal). With this construction, the button height H_{B} at the first end 124 is larger than the button height H_{B} along the trailing region 166 for reasons made clear below. Other shapes or geometries for the engagement surface 162 are also acceptable, and may or may not include the tapered or ramp-like features described above.

Returning to FIGS. 4A-4E, the lock structures 112 are arranged in a circular pattern about (but radially spaced from) the spout 100. As best identified in FIG. 4D, the lock structures 112 are arranged such that the optional tapering shape of the engagement surface 162 (FIG. 4E) of lock retention structure 112 is in the same rotational direction relative to the longitudinal axis A. For example, relative to the orientation of FIG. 4D, the engagement surface 162 of each of the lock structures 112 tapers in the counterclockwise direction (e.g., the first end 124 is rotationally “ahead” of the corresponding second end 126 in the counterclockwise direction).

While FIGS. 4A-4E illustrate the first connection format 56 as including two of the lock structures 112, in other embodiments three or more of the lock structures 112 are provided. A circumferential spacing is established between circumferentially adjacent ones of the lock structures 112 along the circular pattern, and in some embodiments the lock structures 112 are optionally equidistantly spaced about the spout 100.

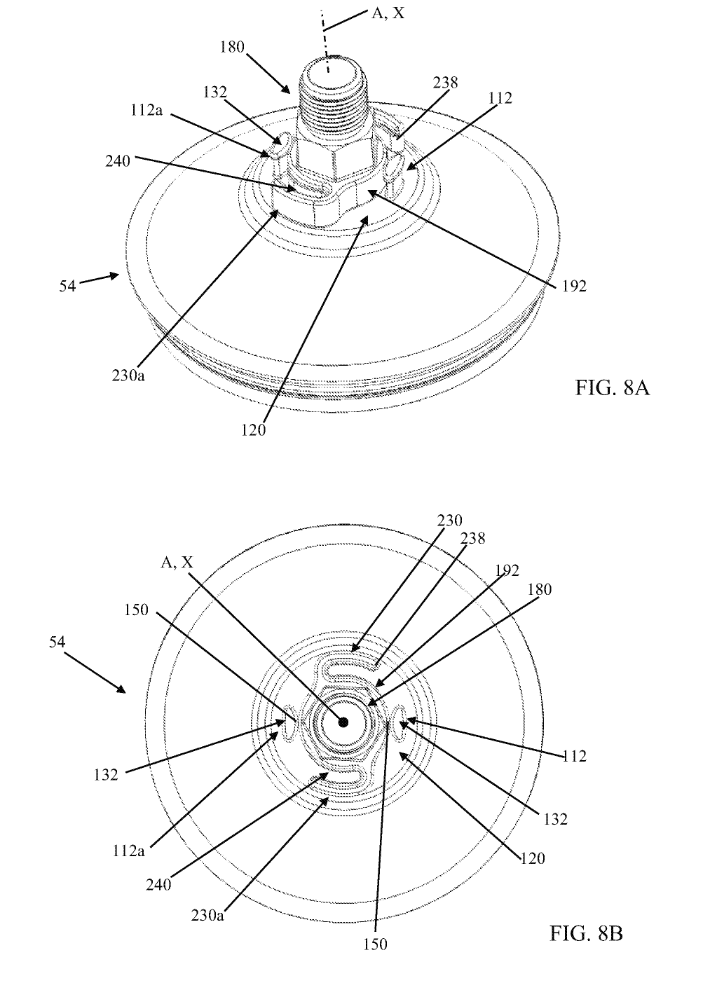

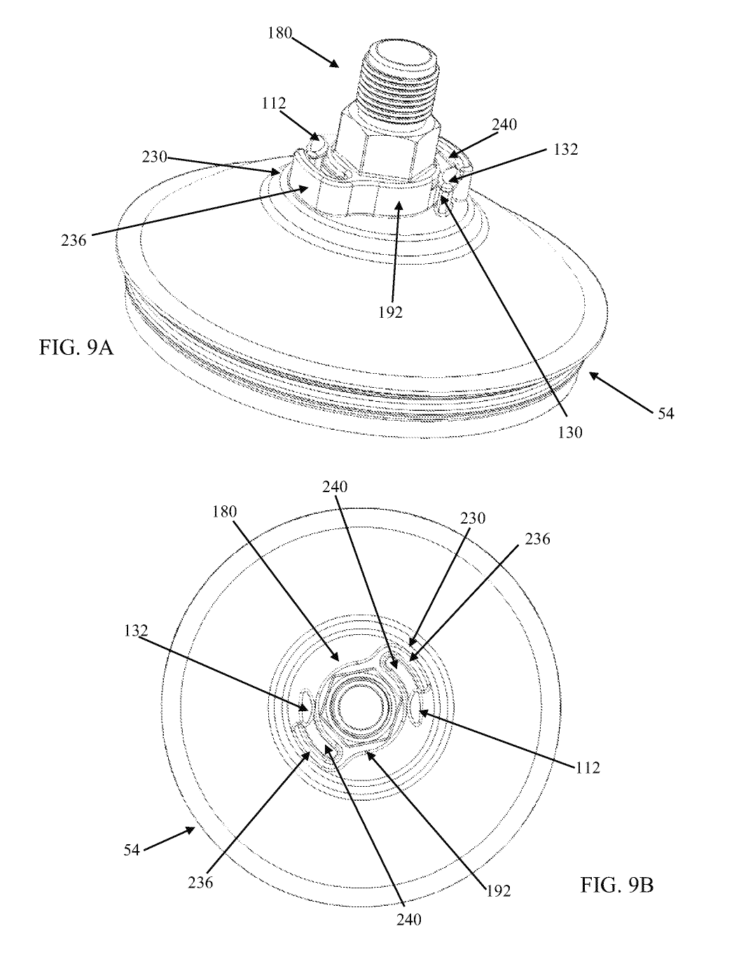

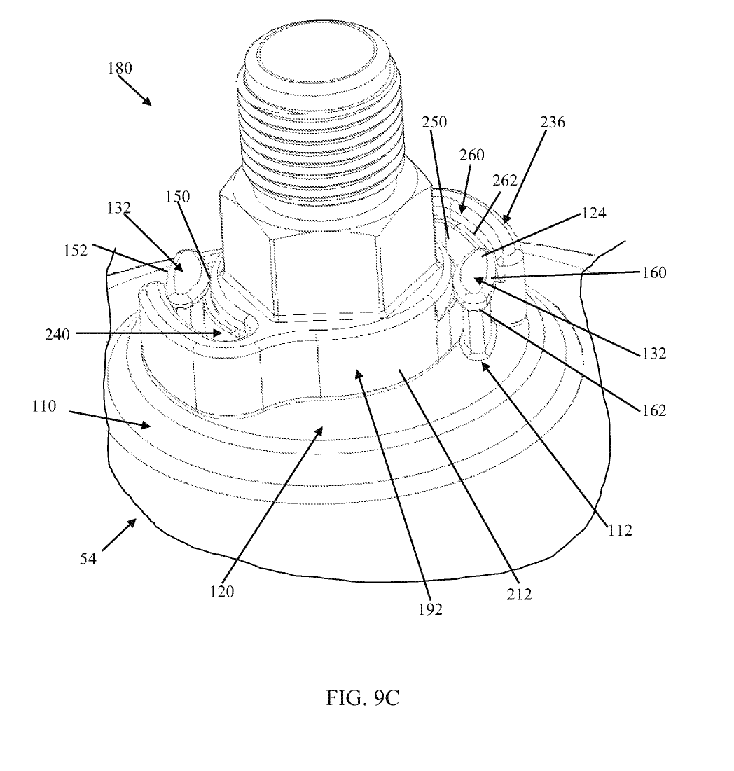

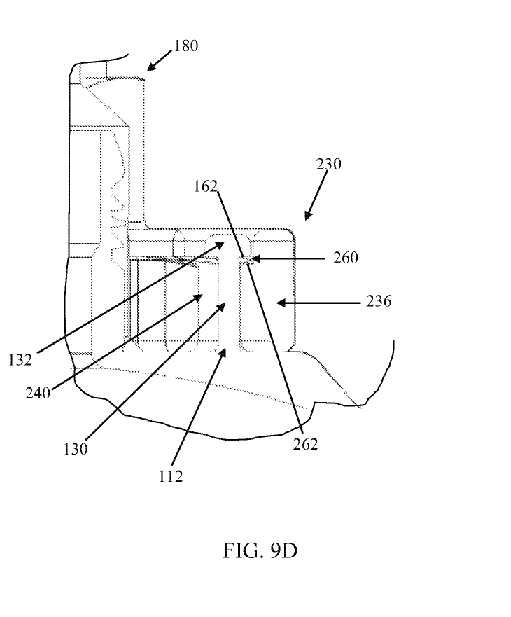

Returning to FIG. 3, the second connection format 72 is configured to selectively mate with features of the first connection format 56. In some embodiments, the second connection format 72 is provided as part of an adaptor, such as an adaptor 180 shown in FIGS. 6A-6D. In addition to the second connection format 72 (referenced generally in FIG. 6A), the adaptor 180 includes a tubular member 190. Details on the various components are provided below. In general terms, a shape of the adaptor 180 defines a central axis X. The tubular member 190 can include or provide features akin to conventional spray gun reservoir connection adaptors, such as for establishing connection to an inlet port of the spray gun. A base 192 of the second connection format 72 projects from the tubular member 190 and carries or defines other portions of the second connection format 72, and promotes mounting of the adaptor 180 to the lid 54 (FIG. 4A).

The tubular member 190 can assume various forms, and defines a central passageway 200 (best shown in FIG. 6D). The passageway 200 is open at a leading end 202 of the tubular member 190. The tubular member 190 forms or provides mounting features that facilitate assembly to a conventional spray gun inlet port. For example, exterior threads 204 can be provided along the tubular member 190 adjacent the leading end 202, configured to threadably interface with threads provided by the spray gun inlet port. In this regard, a pitch, profile and spacing of the exterior threads 204 can be selected in accordance with the specific thread pattern in the make/model of the spray gun with which the adaptor 180 is intended for use. Other spray gun mounting features are equally acceptable that may or may not include the exterior threads 202. The tubular member 190 can optionally further include or define a grasping section 206. The grasping section 206 is configured to facilitate user manipulation of the adaptor 180 with a conventional tool, and in some embodiments includes or defines a hexagonal surface pattern adapted to be readily engaged by a wrench. In other embodiments, the grasping section 206 can be omitted.

The base 192 extends from the tubular member 190 opposite the leading end 202, and terminates at a trailing end 210. The passageway 200 continues through the base 192, and is open at the trailing end 210. A diameter of the passageway 200 at the trailing end 210 corresponds with a diameter of the spout 100 (FIG. 4A), and is selected such that the trailing end 210 can slidably receive the spout 100 of the lid 54. The base 192 can have a generally cylindrical or ring-like shape, with various features optionally incorporated into an exterior face 212 as described below and that can be considered components of the second connection format 72.

The second connection format 72 includes a plurality of retention structures 230. The retention structures 230 project outwardly from the exterior face 212 and are sized and shaped to selectively engage with corresponding ones of the lock structures 112 (FIG. 4A) as described below.

In some embodiments, the retention structures 230 are identical, and each includes a retention body 232 continuously extending from the base 192 in a curved fashion defining a foot segment 234 and a leg segment 236. Projection of the foot segment 234 from the base 192 includes a component in a radially outward direction, and establishes a curvature differing from a curvature of the exterior face 212 of the base 192. The leg segment 236 extends from the foot segment 234 opposite the base 192, and terminates at a free end 238. The leg segment 236 is thus spaced from the base 192 in the radial direction, generating a slot 240 between the leg segment 236 and the base 192. The slot 240 is open at the free end 238 and is closed at the foot segment 234. Extension of the leg segment 236 generates a curvature that, in some embodiments, approximates a curvature of the exterior face 212 of the base 192 such that the slot 240 has a helical-like shape and a substantially uniform width from the free end 238 to the foot segment 234. As best illustrated by FIG. 6C, the leg segments 236 project from the corresponding foot segment 234 in the same rotational direction relative to, or about, the central axis X. For example, relative to the orientation of FIG. 6C, each of the leg segments 236 extend from the corresponding foot segment 234 in a clockwise direction (e.g., the free end 238 is rotationally “ahead” of the corresponding second foot segment 234 in the clockwise direction). With embodiments in which two of the retention structures 230 are provided, the adapter 180 can have the S-like shape conveyed by view of FIG. 6C.

With specific reference to FIG. 6D, the retention body 232 defines an internal face 250, an external face 252, and opposing first and second guide faces 254, 256. The slot 240 is defined between the internal face 250 of the retention body 232 (along the leg segment 236) and the exterior face 212 of the base 192. The first guide face 254 can be flush or co-planar with a plane of the trailing end 210 of the base 192 in some embodiments. A groove 260 is optionally defined in the retention body 232 at a region of intersection of the internal face 250 and the second guide face 256. A bearing face 262 is defined by the groove 260. The groove 260 can extend continuously along the retention body 232, and further continues to base 192. That is to say, and as shown in FIG. 4D, the groove 260 is also defined in the exterior face 212 of the base 192. A size and shape of the groove 260, as well as a longitudinal location of the groove 260 relative to the first guide face 254 corresponds with geometry features of the first connection format 56 (FIG. 4A) as made clear below. In other embodiments, the groove 260 can be omitted.

While FIGS. 6A-6D illustrate the second connection format 72 as including two of the retention structures 230, in other embodiments three or more of the retention structures 230 are provided, with the number of retention structures 230 optionally matching the number of lock structures 112 (FIG. 4A) provided with the complementary first connection format 56 (FIG. 4A). Similarly, a spacing between circumferentially adjacent ones of the retention structures 230 mimics the circumferential spacing between the lock structures 112 (e.g., the retention structures 230 are optionally equidistantly spaced about the base 192 in some embodiments).

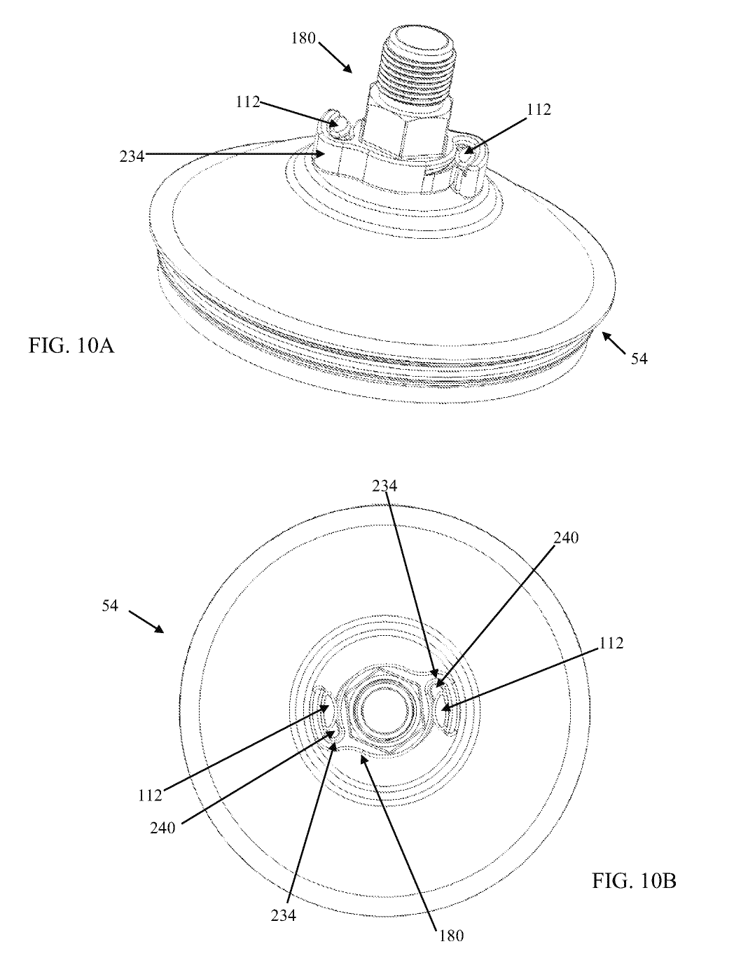

With reference to FIG. 7, engagement between the first and second connection formats 56, 72 (and thus between the lid 54 and the adaptor 180) initially entails aligning the adaptor 180 with the fluid outlet 64. The lid 54 and adaptor 180 are spatially arranged such that the trailing end 210 of the adaptor 180 faces the contact surface 120 of the lid 54, and the retention structures 230 are rotationally off-set from the lock structures 112. The lid 54 and adaptor 180 are then directed toward one another, bringing the first guide face 254 (FIG. 6D) of the adaptor 180 into contact with contact surface 120 of the lid 54 as shown in FIGS. 8A and 8B. The base 192 is located over the spout 100 (hidden in FIGS. 8A and 8B, but shown, for example, in FIG. 7), and the central axis X of the adaptor 180 is aligned with the longitudinal axis A of the lid 54. An outer diameter of the base 192 is less than a diameter collectively generated by the interior surface 150 of the button head 132 of the lock structures 112, allowing the base 192 to nest over the spout 100 “inside” of the lock structures 112. In the initial state of FIGS. 8A and 8B, the retention structures 230 are rotationally spaced from the lock structures 112. However, due to corresponding geometries of the lid 54 and the adaptor 180, engagement between the contact surface 120 and the first guide face 254 (FIG. 6D) circumferentially aligns the lock structures 112 with the retention structures 230 (e.g., FIGS. 8A and 8B illustrate the slot 240 of the first retention structure 230a being circumferentially aligned with the first lock structure 112a).

The adaptor 180 is then rotated relative to the lid 54 (and/or vice-versa) about the common axes A, X, in a direction that moves the free end 238 of each of the retention structures 230 toward the first end 124 of a corresponding one of the lock structures 112. For example, relative to the orientation of FIG. 8B, the adaptor 180 is rotated clockwise relative to the lid 54. With this rotation, the slot 240 of each of the retention structures 230 is directed to receive a corresponding one of the lock structures 112. FIGS. 9A and 9B illustrate initial interface between corresponding pairs of the lock structures 112 and the retention structures 230. A diameter collectively defined by the leg segments 236 approximates a diameter collectively defined by the stems 130 such that the slots 240 are radially positioned to interface with or receive a corresponding one of the lock structures 112. As the retention structure 230 approaches the corresponding lock structure 112, the stem 130 enters the free end of the slot 240. Further, the button head 132 interfaces with surfaces of one or both of the leg segment 236 and the base 192.

In particular, and with specific reference to FIG. 9C, the adaptor 180 is flush against the contact surface 120 of the platform 110, dictating that a longitudinal location of the engagement surface 162 (referenced generally) of the button head 132 relative to the groove 260 (and thus the bearing face 262) is fixed (via a corresponding geometries of the lid 54 and the adaptor 180). In other words, the button height H_{B} (FIG. 4A) intersects with a vertical location of the groove 260. The button head 132 is slideably received within the groove 260 along both the leg segment 236 and the base 192. Though not directly visible in FIG. 9C, it will be recalled that in some embodiments, the engagement surface 162 has a tapered or wedge shape in extension from the first end 124. The lip 160 of the lock structure 112 is readily received by the groove 260 as the first end 124 of the lock structure 112 “enters” the slot 240. This relationship is further reflected by the partial cross-sectional view of FIG. 9D. FIG. 9D also better clarifies a relationship between the engagement surface 162 and the groove 260 (referenced generally) as the button head 132 initially enters the slot 240 (referenced generally). As shown, at this point of the coupling process, the engagement surface 162 freely nests within the groove 260 and does not contact the bearing face 262. Returning to FIG. 9C, due to corresponding or matched curvatures and radiuses of the interior surface 150 of the button head 132 and the exterior face 212 of the base 192, as well as the exterior surface 152 of the button head 132 and the internal face 250 along the leg segment 236, the adaptor 180 can continue to be rotated relative to the lid 54 (and vice-versa). As the lock structure 112 is further progressed or advanced into the slot 240, the engagement surface 162 will being to overtly contact or slidingly abut the bearing face 262 of the groove 260 at both the base 192 and the leg segment 236. A wedge-like coupling or engagement is established between the lock structure 112 and the retention structure 230 due to tapering shape of the engagement surface 162. The angle or plane of sliding engagement (with rotation of the lid 54 and the adaptor 180 relative to one another) between the engagement face 162 and the base 192 and leg segment 236 directs the adaptor 180 into more robust engagement with the lid 54, forcing the base 192 and the leg segment 236 toward the contact surface 120 of the lid 54.

With continued rotation of the adaptor 180 relative to the lid 54 (and/or vice-versa), the button head 132 of each lock structure 112 will become frictionally and mechanically retained within the slot 240 of a respective one of the retention structures 230. FIGS. 10A and 10B illustrate a locked state of the adaptor 180 and the lid 54. Each one of the lock structures 112 is fully nested within a corresponding one of the slots 240. The foot segment 234 prevents the lock structures 112 from passing entirely through or beyond the corresponding slot 240 and thus prevent over-rotation of the adaptor 180. The cross-sectional view of FIG. 10C further illustrates that in the locked state, the engagement surface 162 of the button head 132 robustly contacts or engages the bearing face 262 at both the base 192 and the leg segment 236, and the first guide face 254 of the leg segment 236 is held tightly against the contact surface 120. In some embodiments, interference is created by interaction of the locking faces and retention structures such that the components “bite” into one another to provide increased friction and retention.

Following use, the adaptor 180 can be released from the lid 54 by rotating the adaptor 180 relative to the lid 54 in an opposite direction (e.g., counterclockwise) to withdraw the lock structures 112 from the corresponding retention structures 230. A reversed camming-type interface between the lock structures 112 and the retention structures 230 can occur with rotation of the adaptor 180 (i.e., an interface in reverse of the above descriptions) in some embodiments, serving to assist in releasing any seal between the adaptor 180 and the lid 54. Once disengaged, the adaptor 180 can be separated from the lid 54.

As mentioned above, in some embodiments, the lid 54 and the adaptor 180 can be formed of different materials. For example, the lid 54 can be a plastic component (e.g., molded plastic), and the adaptor 180 can be metal (e.g., stainless steel). With these optional constructions, following a spraying operation the adaptor 180 can easily be cleaned and re-used, and the lid 54 can be viewed as a disposable item.

Returning to FIG. 3, while the above descriptions have provided the complementary second connection format 72 as part of the adaptor 180 (FIG. 5A), other configurations are also acceptable. For example, the second connection format 72 can be permanently assembled to or provided as an integral part of a spray gun (e.g., the second connection format 72 as described above can be provided as or at the inlet port 48 (FIG. 1) of the spray gun 30 (FIG. 1)). That is to say, the spray gun reservoir connector systems of the present disclosure do not require an adaptor.

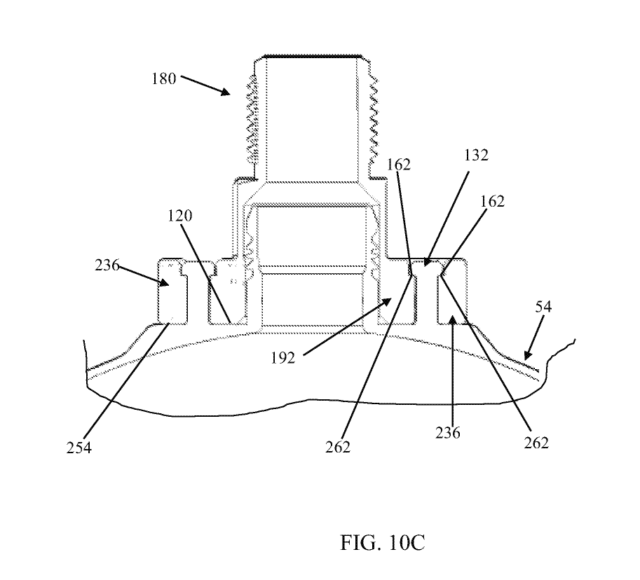

In addition, the location of the first and second connection formats 56, 72 can be reversed. In other embodiments, then, the second connection format 72 can be formed or provided with the lid 54, and the first connection format 56 can be formed or provided with the spray gun inlet 70 (e.g., adaptor, spray gun inlet port, etc.). For example, FIG. 11 illustrates portions of an alternative spray gun reservoir connector system 300 including complementary first and second connection formats 302, 304 (referenced generally). The first connection format 302 is provided as part of a lid 310; the second connection format 304 is provided as part of a spray gun inlet, such as an adaptor 312 as shown. The first connection format 302 can assume any of the forms described above with respect to the second connection format 72 (e.g., FIG. 6A), and includes the base 192 and the plurality of the retention structure structures 230 projecting from the base 192 to form the slots 240. The second connection format 304 can assume any of the forms described above with respect to the first connection format 56 (e.g., FIG. 4A), and includes the lock structures 112 projecting from the contact surface 120 and defining the stem 130 and the button head 132. The connection formats 302, 304 interface with each other as described above.

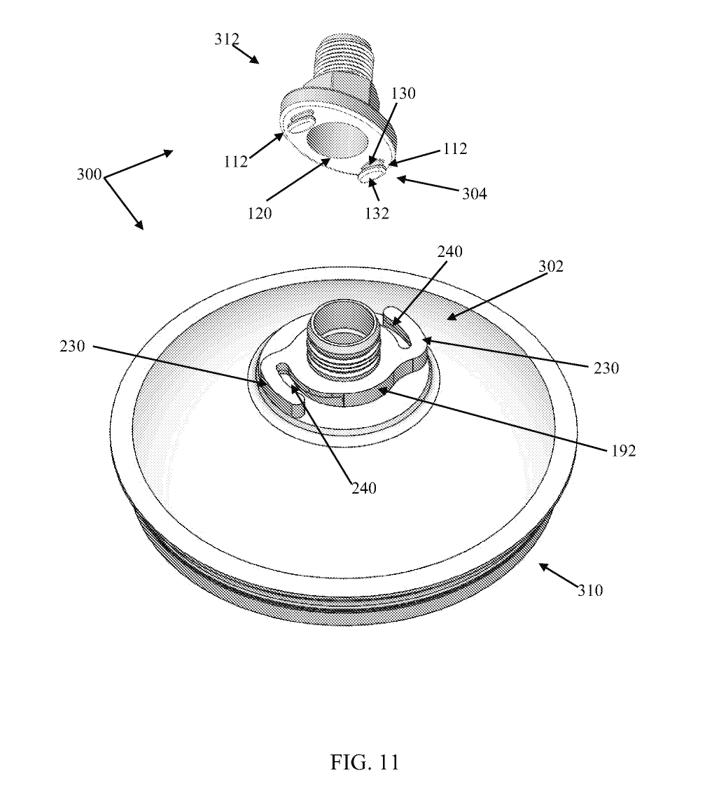

FIG. 12 illustrates portions of an alternative spray gun reservoir connector system 400 including complementary first and second connection formats 402, 404 (referenced generally) in accordance with principles of the present disclosure. The first connection format 402 is provided as part of a lid 410; the second connection format 404 is provided as an integral part of a spray gun inlet, such as an adaptor 412 as shown.

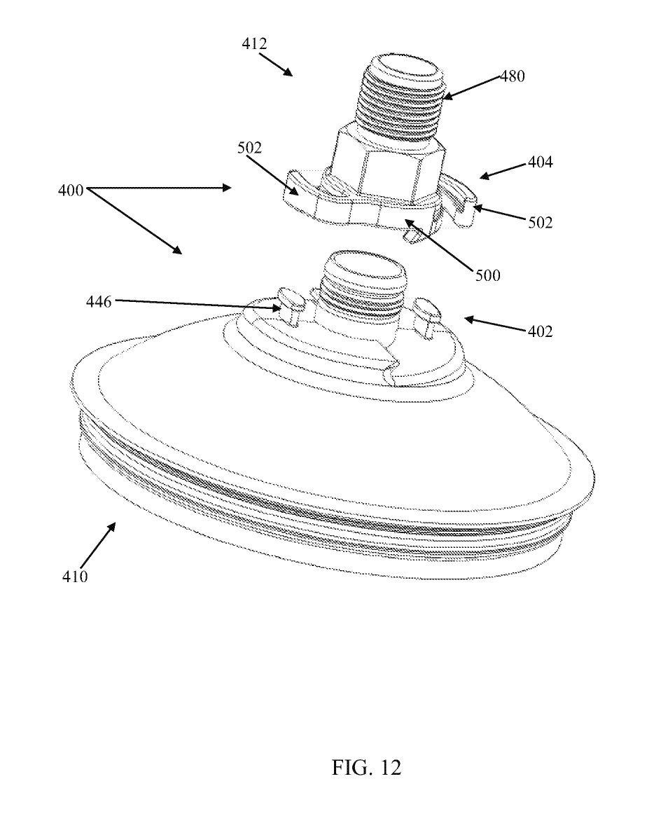

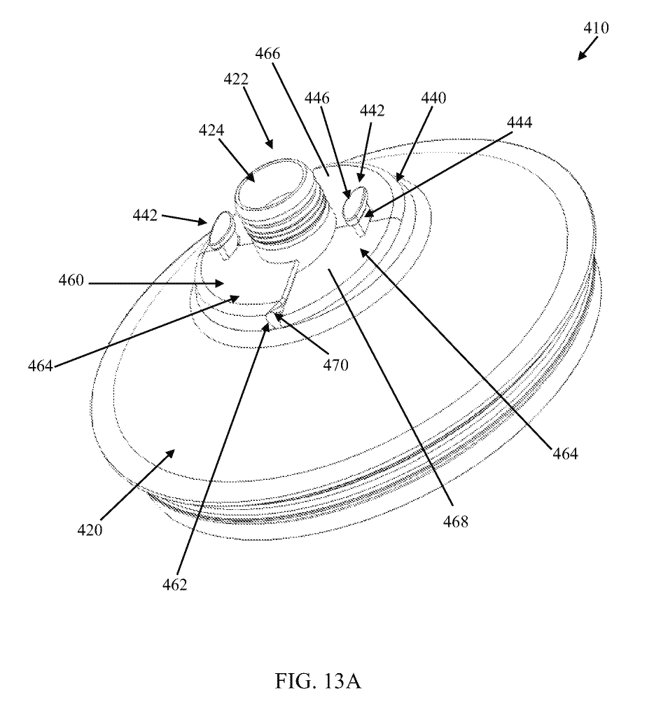

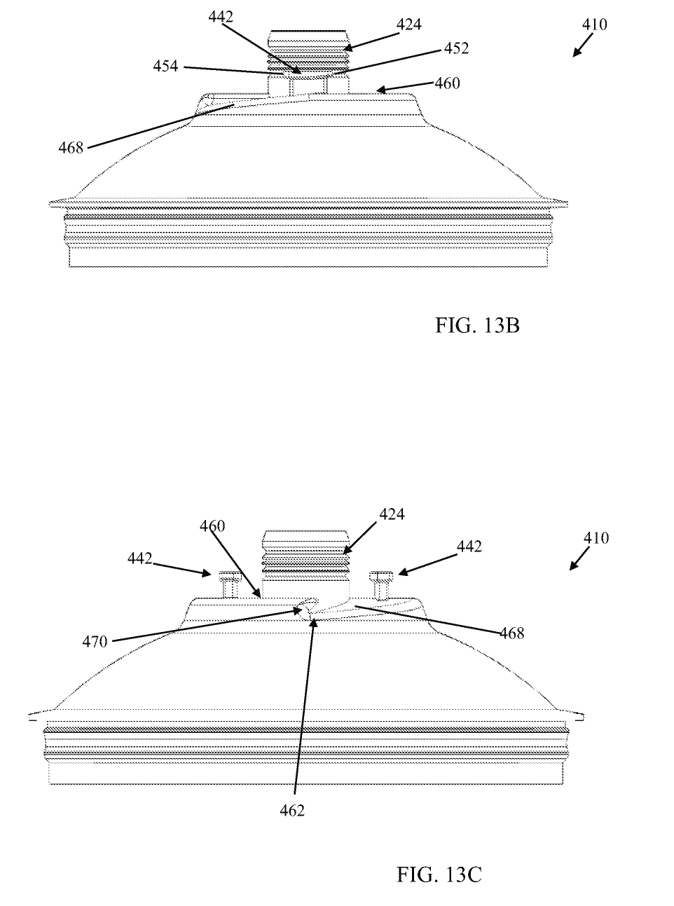

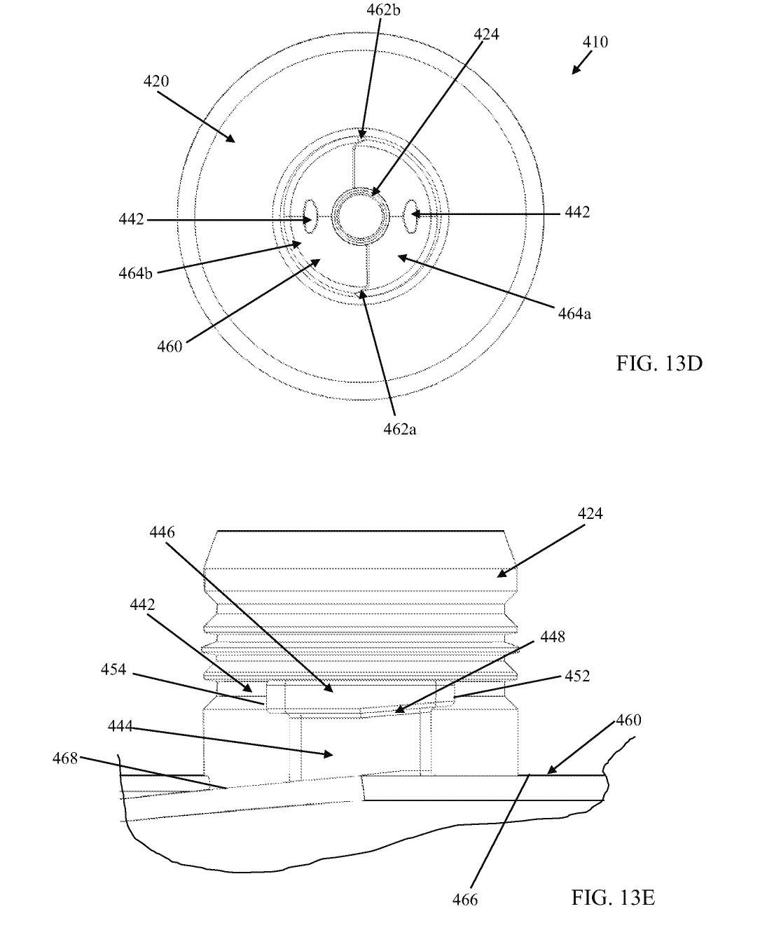

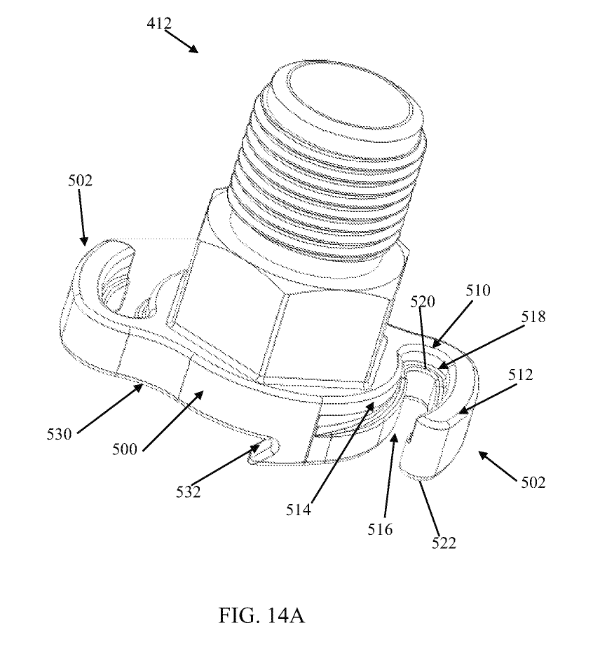

The lid 410 is shown in greater detail in FIGS. 13A-13E and in many respects can be highly akin or identical to the lid 54 (FIG. 4A) described above. The lid 410 generally includes a wall 420 and a fluid outlet 422. The fluid outlet 422 includes a spout 424 along with optional sealing features as described above.

The first connection format 402 (referenced generally in FIG. 13A) includes a platform 440 and a plurality of lock structures 442. The lock structures 442 can be highly akin, and optionally identical, to the lock structures 112 (FIG. 4A) described above. The lock structures 442 can have any of the attributes or features described above with respect to the lock structures 112, and are arranged in a circular pattern at about (and radially spaced from) the spout 424. In general terms, each of the lock structures 442 includes a stem 444 and a button head 446. The stem 444 and/or the button head 446 can have any of the geometries or shapes described above (e.g., an ellipse-like shape). The button head 446 projects radially beyond a shape of the corresponding stem 444 to define an engagement surface 448 commensurate with the explanations above. In some embodiments, the engagement surface 448 can include or define a ramp or tapering segment that tapering in height (relative to the platform 440) from a first end 452 of the lock structure 442 toward an opposing second end 454.

The platform 440 is functionally akin to the platform 110 (FIG. 4A) described above, and defines a contact surface 460 from which the stems 444 project. In contrast to other embodiments discussed above, the platform 440 is configured such that the contact surface 460 has a varying shape about the spout 424. In particular, a plurality of undercuts 462 are defined in the platform 440. The contact surface 460 forms a discrete guide region 464 in extension between adjacent ones of the undercuts 462 about the spout 424; the number of undercuts 462 can correspond with the number of lock structures 442, and the number of guide regions 464 corresponds with the number of undercuts 462. As identified in FIG. 13D, with the non-limiting example of FIGS. 13A-13E, two undercuts (first and second undercuts 462a, 462b) are formed, as are two of the guide regions (first and second guide regions 464a, 464b), although any other number is equally acceptable.

At least a portion of each of the guide regions 464 forms a partial helical shape, transitioning longitudinally as the contact surface 460 revolves about the spout 424. For example, each of the guide regions 464 can include a lead-in section 466 and a ramp section 468. The lead-in section 466 initiates “upstream” of the first end 452 of the corresponding lock structure 442. A plane of the lead-in section 466 is substantially perpendicular to a central axis of the lid 410. The ramp section 468 tapers longitudinally downward (relative to the upright orientation of the views) from the lead-in section 466. Relative to an upright orientation of the views, the lead-in section 466 is longitudinally or vertically “above” the ramp section 468. In other embodiments, the contact surface 460 can define a continuous downward or longitudinal taper between the corresponding undercuts 462. As highlighted by the enlarged view of FIG. 13E, in some embodiments a transition of the contact surface 460 from the lead-in section 466 to the ramp section 468 corresponds with a transition in the tapering shape of the engagement surface 448 of the button head 446. Finally, and as shown in FIG. 13A, a shoulder 470 is defined at each of the undercuts 462 for reasons made clear below.

Returning to FIG. 12, the adaptor 412 can be highly akin to the adaptor 180 (FIG. 6A) described above, and generally includes a tubular member 480. The tubular member 480 can include any of the features described above with respect to the tubular member 190 (FIG. 6A). The second connection format 404 includes a base 500 and a plurality of retention structure structures 502. The base 500 projects from the tubular member 480, and carries the retention structures 502. The retention structures 502, in turn, are configured to selectively interface with corresponding ones of the lock structures 442 as described below

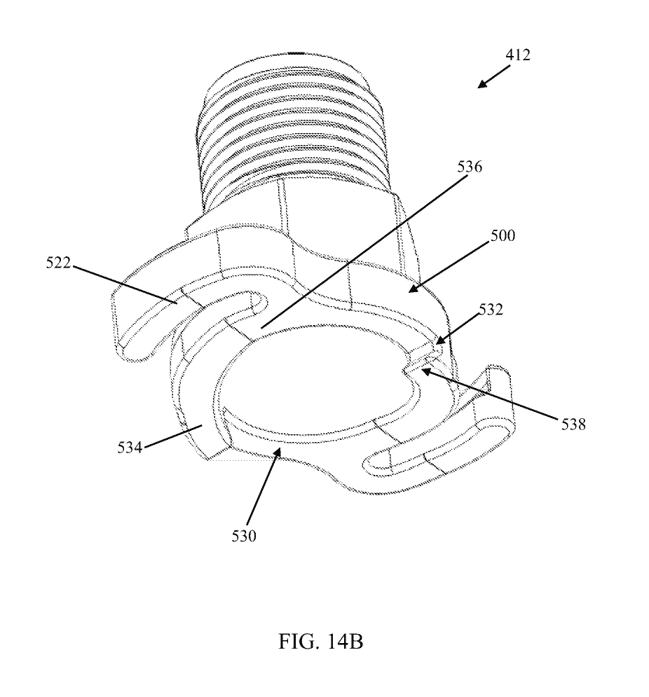

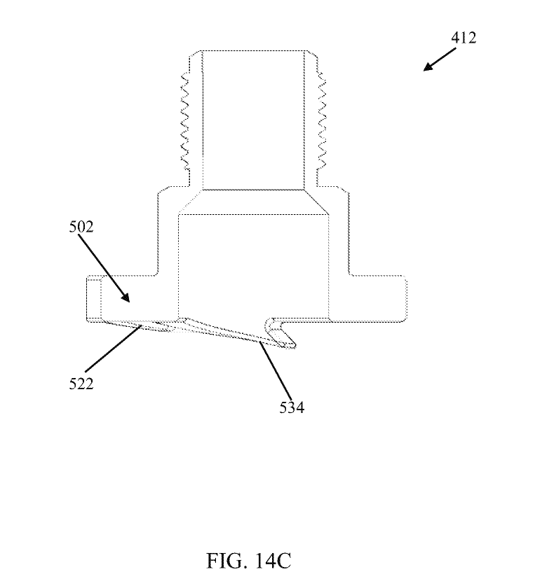

As reflected by the illustration of FIG. 14A, the retention structures 502 can be highly akin, and optionally identical, to the retention structures 230 (FIG. 6A) described above. The retention structures 502 can have any of the attributes or features described above with respect to the retention structures 230, and are arranged in a circular pattern at about (and extend from) the base 500. In general terms and commensurate with the detailed discussions above, each retention structure 502 includes a foot segment 510 and an arm segment 512 in extension from an exterior surface 514 of the base 500. A slot 516 is defined between the arm segment 512 and the base 500. A groove 518 extends along the arm segment 512 and the exterior surface 514, and generates a bearing surface 520. Finally, the retention structures 502 each define a guide face 522 (referenced generally in FIG. 14A).

The base 500 is highly akin to the base 192 (FIG. 6A) described above, and reference is made to previous descriptions for a more detailed explanation. The base 500 forms a trailing face 530 that establishes a geometry corresponding with a shape of the contact surface 460 (FIG. 13A) as described above. A plurality of undercuts 532 are formed along the trailing face 530. Further, and as best shown in FIG. 14B, the trailing face 530 generates a track section 534 and a flat section 536 circumferentially between adjacent ones of the undercuts 532. The track section 534 projects longitudinally outwardly in extension from the corresponding flat section 536 akin to a partial helix, and terminates at a tab 538. The flat section 536 can be substantially planar or flat, and is can be co-planar or aligned with the guide face 522. FIG. 14C illustrates that in some embodiments, the track section 534 projects longitudinally beyond the guide face 522.

Returning to FIG. 12, coupling of the lid 410 and the adaptor 412 is commensurate with previous explanations. First, the base 500 is aligned with the spout 424, and the adaptor 412 is rotationally arranged such that the retention structures 502 are rotationally off-set from the lock structures 442. The adaptor 412 is then directed on to the lid 410 (and/or vice-versa), with the spout 424 nesting within the base 500. With reference between FIGS. 13A, 14A, and 14B, the trailing face 530 of the base 500 is in sliding contact with the contact surface 460, including each of the track sections 534 of the trailing face 530 in contact with a corresponding one of the lead-in sections 466 of the contact surface 460. As the adaptor 412 is then rotated relative to the lid 410 (and/or vice-versa), the trailing face 530 rides along the contact surface 460, with an interaction at the lead-in section 466 and the ramp section 468 brining the retention structures 502 into alignment with respective ones of the lock structures 442. Once aligned, the lock structures 442 and retention structures 502 interface with one another as described above to engage or lock the adaptor 412 relative to the lid 410.

While the above descriptions have provided the complementary second connection format 404 (referenced generally in FIG. 12) as part of the adaptor 412, other configurations are also acceptable. For example, the second connection format 404 can be permanently assembled to or provided as an integral part of a spray gun (e.g., the second connection format 404 as described above can be provided as or at the inlet port 48 (FIG. 1) of the spray gun 30 (FIG. 1)). In addition, the location of the first and second connection formats 402, 404 can be reversed. In other embodiments, then, the second connection format 404 can be formed or provided with the lid 410, and the first connection format 402 can be formed or provided with a spray gun inlet (e.g., adaptor, spray gun inlet port, etc.).

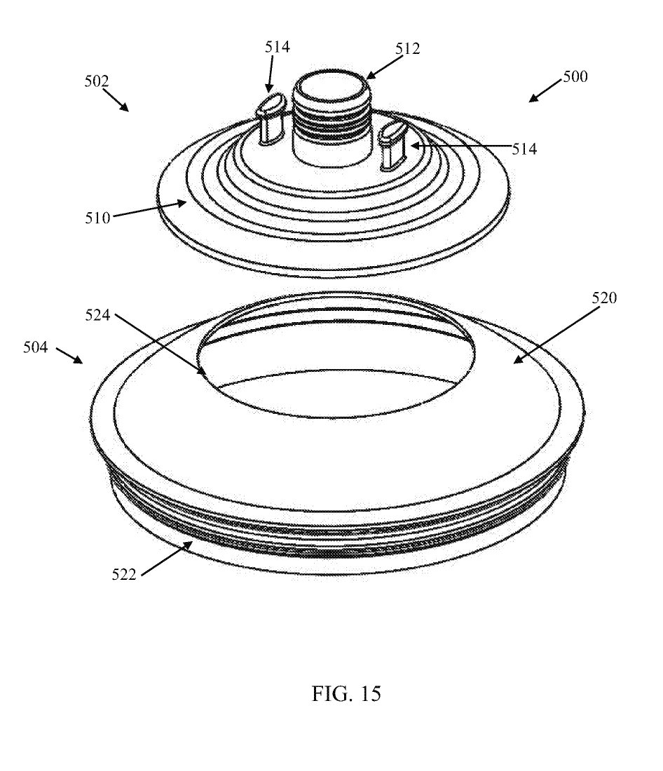

Any of the complementary connection formats described in the present disclosure may be formed integrally with a remainder of the corresponding lid. Alternatively, these components may be initially formed as a separate, modular part or assembly comprising connection geometry to permit connection to a remainder of the lid. For example, a modular lid assembly 500 is shown in FIG. 15 and includes a modular liquid outlet 502 and a modular lid base 504. The modular components 502, 504 are separately formed and subsequently assembled. In general terms, the modular liquid outlet 502 includes a stage 510, a liquid outlet 512 and components of a connection format 514 (referenced generally). The stage 510 is sized and shaped in accordance with a corresponding feature of the modular lid base 504 described below, and supports the liquid outlet 512 and the connection format 514. The connection format 514 can assume any of the forms described above, and in the non-limiting example of FIG. 15, can be the first connection format 56 (FIG. 4A) as described above. Any other connection format described herein can alternatively be incorporated into the modular liquid outlet 502.

The modular lid base 504 generally includes a wall 520 and a rim 522 projecting form the wall 520. The wall 520 forms a central opening 524, and is sized and shaped in accordance with a size and shape of the stage 510. The central opening 524 can assume various shapes and sizes, but is generally configured such that an outer diameter of the opening 524 is greater than an inner diameter of the liquid outlet 512, and less than an outer diameter of the stage 510.

Assembly of the modular lid assembly 500 includes securing the stage 510 on to the wall 520, with the central opening 524 being open to the liquid outlet 512. The modular liquid outlet 502 is secured to the modular lid base 504 by way of welding and/or an adhesive or the like in some embodiments. In some embodiments, the adhesive joint and/or weld joint act to both retain and create a liquid-tight seal upon assembly of the modular liquid outlet 502 to the modular lid base 504. Other attachment techniques are also acceptable, such as quarter turn locking, provision of mechanical locking mechanisms, threaded, snap fit, other mechanical fasteners (e.g., screws, rivets and/or molded posts that are cold formed/hot formed and mushroomed down to hold/retain the component(s) in place and provide a suitable leak-proof seal).

Constructing the lid 500 using a modular liquid outlet 502 and a modular lid base 504 can provide an advantage of allowing more complex geometries to be feasibly created than may otherwise be possible using, e.g., injection molding. For example, in a given lid 500, it may be impossible to form a particular geometry in an injection molded part due to the locations of mold parting lies and the necessary trajectory of slides required to form certain features. However, if the lid 500 is split into modular components, tooling can be designed to directly access surfaces of each modular component that would not have been accessible on the one-piece lid. Thus, further geometric complexity can be achieved.

The modular lid components 502, 504 may also be constructed of different materials as desirable for the application. For example, it may be desirable to use an engineering plastic for the modular liquid outlet 502 (due the strength and tolerances required for a secure and durable connection to the spray gun), while lower cost polymers could be used for the modular lid base 504.

In other embodiments, the modular liquid outlet 502 provided as above could alternatively be attached or preassembled to the end of a paint supply line or pouch etc. and in turn connected to the spray gun paint inlet port. In this way, paint could be supplied directly to the spray gun without the need for the modular lid base 504 (or other reservoir components)

The spray gun reservoir connector systems of the present disclosure provide a marked improvement over previous designs.

Although the present disclosure has been described with reference to preferred embodiments, workers skilled in the art will recognize that changes can be made in form and detail without departing from the spirit and scope of the present disclosure.

1. A spray gun reservoir connector system comprising:
a reservoir including a lid;
a spray gun inlet;
a first connector format provided with one of the lid and the spray gun inlet, the first connector format including a plurality of retention structures projecting from a base to define a plurality of slots, wherein the retention structures are collectively arranged in a circular pattern and are circumferentially spaced from one another; and
a second connector format provided with the other of the lid and the spray gun inlet, the second connector format including a plurality of lock structures each including a stem and a button head configured to selectively interface with the slot of a respective one of the retention structures, wherein the lock structures are collectively arranged in a circular pattern and are circumferentially spaced from one another;
wherein the connector formats are configured to provide engagement between the lock structures and corresponding ones of the retention structures upon rotation of the spray gun inlet relative to the lid.

2. The connector system of claim 1, wherein the first connector format is provided with the lid and the second connector format is provided with the spray gun inlet.

3. The connector system of claim 2, wherein the lid further includes a liquid outlet, and further wherein the retention structures are arranged about, and radially spaced from, the liquid outlet.

4. The connector system of claim 1, wherein the second connector format is provided with the lid and the first connector format is provided with the spray gun inlet.

5. The connector system of claim 4, wherein the lid further includes a liquid outlet, and further wherein the lock structures are arranged about, and radially spaced from, the liquid outlet.

6. The connector system of claim 1, wherein the spray gun inlet is on an adaptor adapted to connect to a spray gun.

7. The connector system of claim 6, wherein the adaptor further includes a tubular member and a connector feature configured for connection to a spray gun inlet port.

8. The connector system of claim 6, wherein the first connection format is provided with the adaptor, and further wherein the retention bodies collectively form an S-like shape.

9. The connector system of claim 1, wherein the spray gun inlet is integral with a spray gun.

10. The connector system of claim 1, wherein the retention structures each include a retention body defining a foot segment and a leg segment.

11. The connector system of claim 1, wherein the retention structures further include a groove along the corresponding retention body configured to engage a lip of a corresponding one of the button heads.

12. The connector system of claim 11, wherein the button head defines an engagement surface configured to slidably abut a bearing surface formed along a corresponding one of the grooves.

13. The connector system of claim 12, wherein the engagement surface is configured to provide a wedged interface with the bearing surface.

14. The connector system of claim 1, wherein a profile of the button head defines an ellipse-like shape.

15. A spray gun reservoir connector system adapter comprising a first connector format comprising a plurality of retention structures projecting from a base to define a plurality of slots, wherein the retention structures are collectively arranged in a circular pattern and are circumferentially spaced from one another.

16. A spray gun reservoir connector system adapter comprising a second connector format comprising a plurality of lock structures each including a stem and a button head configured to selectively interface with the slot of a retention structure on a compatible first connector format, wherein the lock structures are collectively arranged in a circular pattern and are circumferentially spaced from one another.

17. A spray gun reservoir component comprising a first connector format comprising a plurality of retention structures projecting from a base to define a plurality of slots, wherein the retention structures are collectively arranged in a circular pattern and are circumferentially spaced from one another.

18. (canceled)

19. (canceled)

20. A spray gun reservoir component comprising a second connector format comprising a plurality of lock structures each including a stem and a button head configured to selectively interface with the slot of a retention structure on a compatible first connector format, wherein the lock structures are collectively arranged in a circular pattern and are circumferentially spaced from one another.

21. The spray gun reservoir component of claim 20, wherein the component is a lid.

22. The spray gun reservoir component of claim 20, wherein the component is a pot.
